(19) United States
(12) Patent Application Publication
(10) Pub. No.: US 2026/0222089 A1
(43) Pub. Date: Jul. 30, 2026

(54) HIGH DYNAMIC RANGE RF POWER DETECTOR

(71) Applicant: ViaSat, Inc., Carlsbad, CA (US)

(72) Inventors: David Self, Carlsbad, CA (US); John Schuler, Carlsbad, CA (US)

(73) Assignee: ViaSat, Inc., Carlsbad, CA (US)

(21) Appl. No.: 19/147,287

(22) PCT Filed: Jan. 11, 2023
(86) PCT No.: PCT/US2023/010579

§ 371 Date: Jul. 10, 2025

(51) Int. Cl. H04B 17/318; H04B 1/10

(52) U.S. Cl. CPC H04B 17/318; H04B 1/1027

(57) ABSTRACT

A power meter system, method and device for measuring the power level of a radio frequency (“RF”) input signal over a first input power detection range is disclosed. The power meter comprises: a signal strength adjuster (SSA) to receive an RF input signal, adjust the strength of the RF input signal by an adjustment amount in response to a control signal, and generate an adjusted signal; and a rectifier to rectify the adjusted signal and generate a rectified signal. The rectifier is limited to rectifying over a rectifier input power detection range that is narrower than the first input power detection range. The rectified signal in combination with the adjustment amount represents a detected power in the RF input signal. The power meter further comprises: a controller to control the SSA to cause the adjusted signal to be within a detection range of the rectifier.

### TECHNICAL FIELD

The disclosure relates generally to the field of wireless communications, and more particularly to detecting radio frequency signals over a broad power range.

### BACKGROUND

Traditional radio frequency power detectors may use rectifiers having, for example, a 10 dB power detection range. Recent applications are requiring a much larger/broader power detection range than is possible from such traditional detectors. Considering such limitations, typical solutions to measuring radio frequency signals over a broad power range involve dividing the power range into sections, utilizing several power detectors, each optimized for a discrete, limited power range corresponding to one of the sections, and then combining the final results. However, nonlinearities exist at the boundaries between these power detectors, where the high end of one power detector transitions to the low end of the next power detector. Moreover, the use of multiple power detectors increases the expense, topology area, and power usage of the solutions. Moreover, such solutions often require extensive calibration. Thus, improved broad power detection range solutions for detecting power levels in radio frequency signals would be desirable.

### SUMMARY

In an example embodiment, a power meter for measuring the power level of a radio frequency (“RF”) input signal over a first input power detection range is disclosed. The power meter comprises a signal strength adjuster (SSA) to receive a radio frequency (“RF”) input signal, adjust the strength of the RF input signal by an adjustment amount in response to a control signal, and generate an adjusted signal. The power meter further comprises a rectifier to rectify the adjusted signal and generate a rectified signal. The rectifier is limited to rectifying over a rectifier input power detection range that is narrower than the first input power detection range. The rectified signal in combination with the adjustment amount represents a detected power in the RF input signal. The power meter further comprises: a controller to control the SSA by the control signal that is based on the rectified signal to cause the adjusted signal to be within a detection range of the rectifier.

In an example embodiment, a wireless communication system is disclosed. The wireless communication system comprises a power meter for measuring the power level of a radio frequency (“RF”) input signal. In this example embodiment, the power meter comprises: a signal strength adjuster (SSA) to receive a radio frequency (“RF”) input signal, to adjust the strength of the RF input signal by an adjustment amount in response to a control signal, and to generate an adjusted signal; a rectifier for rectifying the adjusted signal and generating a rectified signal representing a detected power in the RF input signal; and a controller to provide the control signal to the SSA based on the rectified signal to cause the adjusted signal to be within a detection range of the rectifier.

In an example embodiment, a method is disclosed for detecting the power in a radio frequency (“RF”) input signal over a detector operational input power range that is greater than a rectifier operational input power range of a single rectifier used in the detector. The method comprises: receiving at a signal strength adjuster (SSA) an RF input signal; receiving at the SSA at least one control signal; adjusting the strength of the RF input signal by an adjustment amount to generate an adjusted signal, wherein the adjustment amount is based on the at least one control signal; rectifying, with a single rectifier, the adjusted signal to generate a rectified signal; generating, at a controller, the at least one control signal based on the rectified signal to cause the adjusted signal to be within a detection range of the single rectifier; and generating a power detector output signal representing the power in the RF input signal, based on the rectified signal and an amount of adjustment made by the SSA.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates a portion of an example power meter, in accordance with example embodiments;

FIG. 2 illustrates a portion of another example power meter, in accordance with example embodiments;

FIG. 3 illustrates a portion of yet another example power meter comprising discrete attenuators and a controller, in accordance with example embodiments;

FIG. 4 a method for dynamically detecting the power of an RF input signal over a range larger than that of the rectifier doing the detecting, in accordance with example embodiments.

### DETAILED DESCRIPTION

While exemplary embodiments are described herein in sufficient detail to enable those skilled in the art to practice the invention, it should be understood that other embodiments may be realized and that logical electrical and mechanical changes may be made without departing from the spirit and scope of the invention. Thus, the following detailed description is presented for purposes of illustration only.

In wireless communication systems or other systems employing radio frequency (“RF”) signals, a power level of a received or transmitted RF signal may be useful with respect to performing processing on or with the radio frequency signal. These systems may employ one or more of the traditional power meters that measure or otherwise detect the power level of the RF signal. In many embodiments, these systems are exposed to RF signals having a wide range of power levels, where an operational range of a respective power meter may exceed a power detection range of one or more rectifiers used in the power meter to measure the power level of the RF signals. Thus, the traditional power meters may be unable to measure the power levels of radio frequency signals that exceed the power detection range of the one or more rectifiers without increased component cost, circuit complexity, and so forth.

To overcome these deficiencies, example embodiments of power meters described herein for use in such systems, and methods of use thereof, employ feedback mechanisms to actively adjust the RF input signal to be within the power detection range of the respective rectifier(s). By enabling such adjustments to the RF signal, the power meters disclosed herein can generate accurate measurements of the power level of the RF signal within the operational range that otherwise exceeds the power detection range of the rectifier. In accordance with various example embodiments, the feedback mechanisms of the power meters effectively increase the operational range of the power meters without changing the power detection range of the rectifier and, thereby, without increasing the power and area consumption of the power detector or expenses associated with the power detector as compared to traditional power detectors.

In accordance with various example embodiments, a wireless communication system comprises a power meter configured to measure the power level of an RF input signal, where the operational range of the power meter is greater than that suitable for traditional power meters. In an example embodiment, the power level of the RF input signal is greater than power level limits (i.e., the power detection range) of the rectifier doing the detecting. Although the power meter described herein is used in a wireless communication system, the power meter can be used in any suitable RF signal application, such as RADAR systems, cellular transceivers, satellite transceivers, radio signal monitoring systems, and so forth.

In accordance with an example embodiment, a power meter comprises a signal strength adjuster (“SSA”), a rectifier, and a controller. In an example embodiment, the power meter is configured to measure the power level of an RF input signal over a first input power detection range (i.e., the operational power range) associated with the power meter. In an example embodiment, the first input power detection range is a broad power range that may saturate the rectifier if the power level of the RF input signal is not adjusted, for example, to be within a power detection range of the rectifier. In an example embodiment, the power meter utilizes feedback to the SSA to adjust the power level of the RF input signal that is fed into the rectifier. For example, the RF input signal may be fed through the SSA (such as a variable attenuator) that adjusts (e.g., attenuates) the power level of the RF input signal, based on the feedback, to be within the power detection range of the rectifier. The power meter is then configured to provide an accurate measure of the power level of the RF input signal based on a combination of a rectified signal generated by the rectifier and the feedback (e.g., an amount of adjustment applied by the SSA).

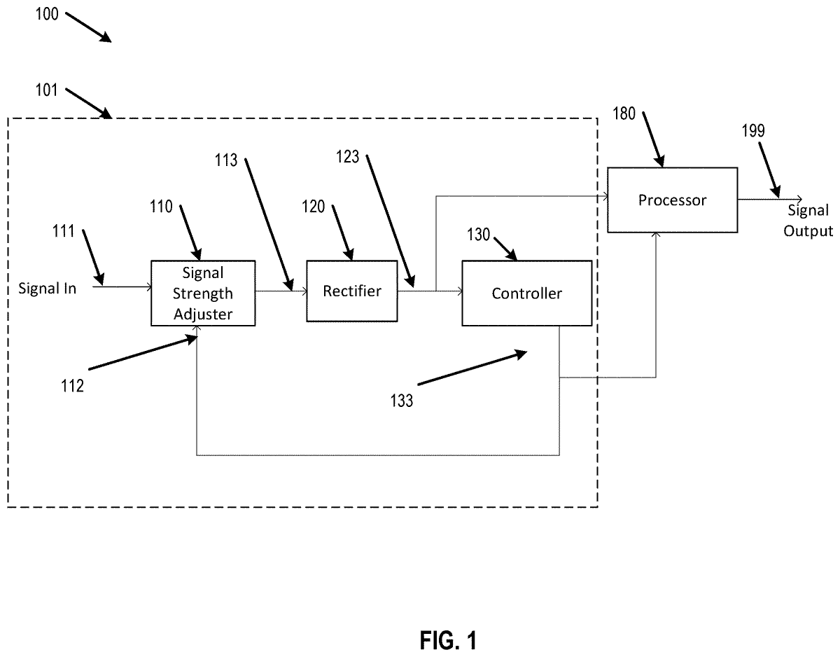

More specifically, in an example embodiment, the SSA is configured to receive the RF input signal and adjust the strength (i.e., power level) of the RF input signal to generate an adjusted signal. The rectifier may be configured to receive the adjusted signal and generate the rectified signal, which is provided to the controller, and the controller may be configured to provide a control signal back to the SSA. This control signal sent to the SSA may correspond to the feedback introduced above. In a further example embodiment, the controller is a comparator. Moreover, in another example embodiment, the power meter comprises a comparator and a controller. In this example embodiment, the comparator is configured to provide a comparator signal to the controller, and the controller is configured to provide the control signal to the SSA, by which the controller can provide different values for the SSA to adjust the RF input signal by different amounts accordingly. Further details are provided below with reference to the Figures. In particular, FIGS. 1-3 are block diagrams illustrating a portion or a relevant subset of components of a complete power meter, without showing or discussing details of various other well-known components of a power meter (which may be present in any practical application of the present disclosure and are included herein by implication).

In accordance with an example embodiment, and with reference to FIG. 1, a power meter 100 is disclosed. In this example embodiment, the power meter 100 comprises an SSA 110, a rectifier 120, and a controller 130. In an example embodiment, the rectifier 120 is connected in signal communication between the SSA 110 and the controller 130, whilst the controller 130 is connected in signal communication between the rectifier 120 and the SSA 110. The signal communication between the controller 130 and the SSA 110 may correspond to or function as a control or feedback signal for the power meter 100. The power meter 100 further comprises a power meter signal input 111 that receives an RF input signal for processing and/or monitoring. The power meter 100 further comprises a power meter signal output 199 that outputs a measurement or indicator of a power level of the RF input signal received at the power meter signal input 111. In an example embodiment, the power meter 100 further comprises a processor 180 for generating a power meter output signal at the power meter signal output 199 based on one or more of an output signal from the rectifier 120, a combination of the output signal from the rectifier 120 and an adjustment amount associated with the feedback signal, and so forth. Further details are provided below.

In an example embodiment, the SSA 110 is connected to or comprises the power meter signal input 111, a SSA control signal input 112, and a SSA signal output 113. The SSA 110 may be configured to receive the RF input signal at or from the power meter signal input 111 and a control signal at or from the SSA control signal input 112. The RF input signal may be a signal for a wireless communication system (such as a transceiver input/output signal), a signal indicating a circuit power level, a noise signal, a voltage controlled oscillator (VCO) generated signal, a monitored radio signal (for example, as used in radio astronomy) or any other raw or processed RF signal.

In some embodiments, the control signal indicates to the SSA 110 an adjustment amount to apply to the RF input signal. More specifically, the control signal may provide to the SSA 110 a value indicating the adjustment amount or a value that the SSA 110 interprets to determine the adjustment amount for the SSA 110, for example, to apply to the RF input signal. The adjustment amount may correspond to an amount of adjustment (e.g., attenuation or gain) to apply to the RF input signal that will place the power level or signal strength of the RF input signal within or closer to a power detection range of the rectifier 120. The SSA 110 may further be configured to adjust the power level of the RF input signal by or based on the adjustment amount in response to the control signal and to generate an adjusted signal at the SSA signal output 113. In one example embodiment, the SSA 110 is an attenuator, such as a variable attenuator. In such embodiments, the SSA 110 may thus be configured to reduce the power in the RF input signal by a variable or fixed amount. The amount of reduction may be indicated by or identified based on the control signal when generating the adjusted signal, as introduced above. In another example embodiment, the SSA 110 is a gain amplifier, such as a variable gain amplifier. In some such embodiments, the SSA 110 may be configured to increase the power in the RF input signal by a variable or fixed amount, where the amount of increase may be indicated by or identified based on the control signal. In some embodiments, the SSA 110 is a fixed gain amplifier configured to increase the power in the RF input signal by a fixed amount, where the amount of increase may not be associated with or based on the control signal but rather on a predetermined value, function, etc. Moreover, the SSA 110 may be any device suitable for decreasing or increasing the gain, and, thus, the power level, of the RF input signal by a desired (fixed or variable) adjustment amount.

In some embodiments, the desired adjustment amount is determined or selected based on the power detection range of the rectifier 120. For example, the desired adjustment amount may correspond to an amount suitable to cause the adjusted signal generated by the SSA 110 to have a power level within or closer to the power detection range of the rectifier 120. For example, the desired adjustment amount may be determined based on the rectifier 120 output exceeding one or more thresholds. Alternatively, the desired adjustment amount may be determined based on a prediction, estimate, look-up table, etc., configured to adjust the power level of the RF input signal to be within or closer to the detection range of the rectifier 120. Thus, the adjustment amount received by the SSA 110 via the control signal may enable the SSA 110 to generate the adjusted signal to have a power level within or closer to the power detection range of the rectifier 120 as compared to the RF input signal without adjustment. In some embodiments, the SSA 110 may generate the adjusted signal without actually adjusting the RF input signal when the control signal indicates that no adjustment is necessary.

In an example embodiment, the rectifier 120 is configured to receive the adjusted signal from the SSA signal output 113, to rectify the adjusted signal, and to generate a rectified signal at a rectifier output 123. This rectified signal may be indicative or representative of the power level of the adjusted signal and, thus, the RF input signal. In an example embodiment, the rectifier 120 produces as the rectified signal a direct current (DC) voltage proportional to the power level of the adjusted signal at the SSA signal output 113. Stated another way, the rectified signal may represent a detected power in the adjusted signal.

In an example embodiment, the rectified signal from the rectifier 120 in combination with the adjustment amount represents a detected power in the RF input signal, as described further below.

As discussed above, in an example embodiment, the rectifier 120 is limited to rectifying the adjusted signal over or within the rectifier power detection range that is narrower than the first input power detection range of the power meter 100. Thus, where the first input power detection range is an operational input power range of the power meter 100 over which the power meter 100 can reliably detect the power level in the RF input signal and the rectifier detection range is a rectifier operational input power range over which the rectifier 120 can reliably detect and rectify the power in the RF input signal, the operational input power range of the power meter 100 can be greater than the rectifier operational input power range of the single rectifier 120 of the power meter 100. In an example embodiment, the operational input power range of the power meter 100 is greater than 40 dB and the rectifier operational input power range of the single rectifier 120 of the power meter 100 is less than or equal to 10 dB. Moreover, in an example embodiment, the first input power range is at least double the rectifier input power range. A variance between the first input power detection range of the power meter 100 and the rectifier power detection range may change according to application. For example, the first input power detection range of the power meter 100 may be many times larger than (for example, 10×, 100×, 1000×, and so forth) the rectifier power detection range or rectifier operational input power of the rectifier 120, or the first input power detection range of the power meter 100 may be marginally larger than (for example, 10%, 50%, 100%, 200%, and so forth) the rectifier power detection range or operational input power of the rectifier 120. In one example embodiment, the operational input power range of the power meter is greater than 20 dB and the operational input power range of the single rectifier of the power meter is less than 10 dB. Thus, but for the feedback discussed herein, the power meter 100 may be unable to provide a reliable output where the rectifier 120 is saturated when measuring the power level of the power meter signal input within the operational input power range of the power meter 100 but outside the rectifier operational input power range of the rectifier 120.

In an example embodiment, the controller 130 is configured to receive the rectified signal representing the detected power in the adjusted signal, from the rectifier output 123. In the example embodiment, the controller 130 is further configured to compare the rectified signal to a predetermined threshold and to generate a control signal at a controller output 133. For example, the controller 130 may comprise an operational amplifier or other component configured to compare the rectified signal to a threshold level, and to generate a control signal representative of whether the rectified signal is below or above the threshold level.

Thus, the control signal may indicate whether the adjusted signal provided to the rectifier 120 can be reliably measured by the rectifier 120. For example, the controller 130 may generate the control signal to indicate whether the signal strength of the adjusted signal generated by the SSA 110 is within the power detection range of the rectifier 120. Stated another way, the controller 130 may generate a feedback signal to cause the power meter 100 to produce a rectified signal at the rectifier output 123 within a predetermined or defined range (e.g., within the power detection range of the rectifier 120). In an example embodiment, the control signal is a voltage level or a current level or otherwise indicates a value of power level adjustment for the SSA 110 to apply to the RF input signal.

In some embodiments, the predetermined threshold corresponds to an expected value or range, for example, of a power level, against which the rectified signal is compared. The predetermined threshold may comprise or correspond to one or more of the power detection range of the rectifier 120, a predetermined or desired power range, and so forth, any of which may be stored in and retrieved from a memory or local storage, received or retrieved from the rectifier 120, received from a user interface, and the like.

Thus, the power meter 100 may comprise a control or feedback loop 101 where the controller 130 provides feedback (e.g., in the form of a control signal) to the SSA 110, based on the rectified signal from rectifier 120, which feedback is used by the SSA 110 to control the amount of adjustment that the SSA 110 applies to the RF input signal such that the adjusted signal provided to the rectifier 120 is within the power detection range of the rectifier 120.

In contrast to traditional power meter topographies for broad power range detection, and in accordance with the various example embodiments set forth herein, the power meter 100 may not comprise rectifiers in parallel or cascaded rectifiers. Rather, in various example embodiments, the power meter 100 may only comprise a single rectifier 120.

As mentioned above, in an example embodiment, the power meter 100 comprises the processor 180 configured to generate a power meter output signal at the power meter signal output 199 that represents or indicates the detected power in the RF input signal by the power meter 100. In an example embodiment, the power meter 100 is able to generate the power meter output signal without the use of rectifier alignment and/or without calibration for alignment of multiple rectifiers.

In one example embodiment, the power meter output signal comprises or corresponds to the rectified signal at the rectifier output 123 in combination with the control signal at the controller output 133. In an example embodiment, the processor 180 may reverse calculate (or otherwise determine) the power level of the RF input signal based on the rectified signal indicating the power level of the rectified signal and the adjustment amount of the control signal indicating how the original RF input signal was adjusted to obtain the rectified signal. The combination of the adjustment amount with the power level of the rectified signal enables determination of the power level of the RF input signal. For example, the processor 180 may receive the control signal and determine an amount of power compensated for by the adjustment applied by the SSA 110 and sum this amount of power with the power level indicated by the rectified signal to calculate the power level of the RF input signal. In some embodiments, for example when the controller 130 comprises a high gain-type comparator, the processor 180 may determine (and the power meter output signal may thus indicate) the detected power level of the RF input signal based on the comparator signal without need of receiving or employing the rectified signal.

In some embodiments described in this application, the control loop 101 is described in the context of a digital control loop. However, it is intended that other embodiments can comprise an analog control loop, similar in function to the digital control loop described herein. For example, the embodiment disclosed in FIG. 1 may be implemented as an analog control loop, such as by having the controller 130 feedback directly to the SSA 110 (as a variable attenuator or variable gain amplifier), where the controller 130 feedback indicates the adjustment amount to apply at the SSA 110, and so forth. In an analog control loop embodiment, any stability concerns can be addressed by allowing a settling time to increase. For example, when the power meter 100 does not comprise any components between the controller 130 and the SSA 110, the controller 130 comprising a comparator may generate the control signal as a true analog output signal. Alternatively, in a power meter comprising a feedback-controller/comparator, the comparator may provide a digital comparator signal to the feedback controller, which may generate the control signal as either an analog or digital signal.

As introduced above, in some embodiments, the SSA 110 receives the control signal from the controller 130 and uses the control signal to identify or control an amount of adjustment that the SSA 110 applies to the RF input signal. For example, when the control signal is a digital control signal, the SSA 110 may change the amount of adjustment applied to the RF input signal when the value of the control signal is ‘0’ and maintain the amount of adjustment applied when the value is ‘1’. In some embodiments, the control signal is an analog control signal that indicates one or more of an amount of adjustment previously applied by the SSA 110 to the RF input signal (for example, on a previous iteration), an amount of adjustment for the SSA 110 to apply to the RF input signal (for example, on a subsequent iteration), and so forth. For example, the SSA 110 may not apply any adjustment to the RF input signal on a first iteration. Accordingly, the controller 130 may generate the analog control signal indicating that the SSA 110 should apply half of a maximum adjustment of the SSA 110 when the adjusted signal is outside of the rectifier operational input power range (for example, pursuant to a binary search or similar algorithm). More specifically, the analog control signal may identify the adjustment amount for the SSA 110 to apply to the RF input signal, indicating a value equal to half of the maximum adjustment of the SSA 110 (or a maximum subsequent adjustment available) or a value that the SSA 110 identifies as instructing the SSA 110 to apply half of its maximum adjustment to the RF input signal. Thus, the SSA 110 may receive the analog control signal to apply an appropriate amount of adjustment to the RF input signal.

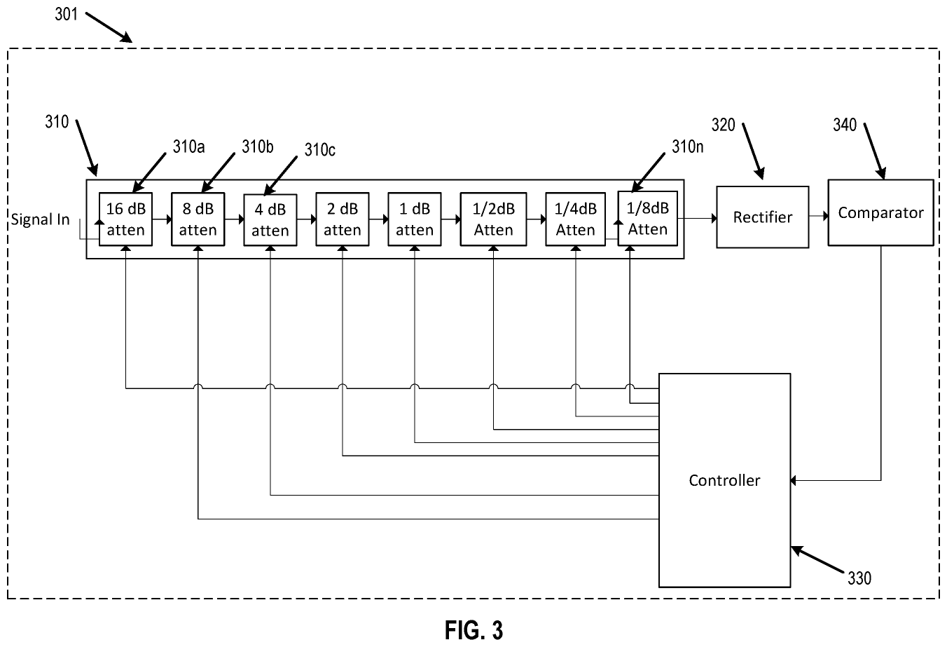

In some embodiments, the SSA 110 comprises a processing or similar component that enables the SSA 110 to interpret the analog or digital control signal and identify the amount of adjustment to apply to the RF input signal accordingly. For example, when the SSA 110 receives the digital control signal with the value of ‘0’, the SSA 110 with the processing component may change the amount of adjustment applied to the RF input signal according to one or more of the binary search algorithm, an iterative adjustment, and so forth. Alternatively, the SSA 110 merely reacts to the analog or digital control signal without any processing. For example, such an SSA 110 receives the analog control signal indicating the amount of adjustment to apply to the RF input signal, and the SSA 110 may activate appropriate components accordingly (for example, activating respective attenuators as indicated by or determined from the analog control signal from the controller, an example of which is provided below with reference to FIG. 3). Similarly, the SSA reacting to the digital control signal with the value of ‘0’ may incrementally increase the adjustment amount applied to the RF input signal when the digital control signal using circuitry without any actual processing of the digital control signal.

In some embodiments, the controller 130 controls the amount of attenuation by the SSA 110 with the control signal. For example, where the controller 130 comprises a comparator, the comparator signal may indicate that the adjusted signal from the SSA 110 is within a power detection range of the rectifier 120 and the feedback controller may provide the control signal, based on the comparator signal, that causes the SSA 110 to not change an adjustment amount (e.g., the amount of attenuation or amplification) applied by the SSA 110 to the RF input signal. On the other hand, if the comparator signal indicates that the adjusted signal from the SSA 110 is not within the rectifier 120 power detection range, the comparator of controller 130 is configured to provide a comparator signal to the feedback controller that generates the control signal that causes the SSA 110 to adjust (for example, iteratively adjust) the adjustment amount applied by the SSA 110 to the RF input signal such that the adjusted signal is within (or closer to) the power detection range of the rectifier 120. As described above, the control signal may indicate to the SSA 110 one or more of the adjustment amount to apply, that an adjustment is needed, and so forth.

In an example embodiment, the controller 130 comprises a state machine, such as a Successive Approximation Register (“SAR”) state machine, a counter, and so forth. In this example embodiment, the state machine controls the amount of attenuation by the SSA 110 with the control signal. In this example embodiment, the state machine may have a first state where it causes the controller 130 to generate a control signal that causes the SSA 110 to not change the adjustment amount, and a second state that causes the controller 130 to generate a control signal that causes the SSA 110 to change the adjustment amount. The state machine may be configured to change between the first state and the second state based on whether the adjusted signal from the SSA 110 is within the detection range of the rectifier 120.

By way of example, where the controller 130 comprises a comparator and a state machine, when a comparator signal from the comparator indicates that the adjusted signal from the SSA 110 is within a power detection range of the rectifier 120, the state machine does not change states and the state machine causes a control signal generated by the controller 130 to not change and, thus, to not cause the SSA 110 to change the adjustment amount (e.g., the amount of attenuation or amplification) applied by the SSA 110 to the RF input signal. On the other hand, if the comparator signal indicates that the adjusted signal is not within the rectifier 120 power detection range, the state machine is configured to change states. In the new state, the controller 130 is caused to output a control signal causing the SSA 110 to change the adjustment amount. After the SSA 110 has changed the adjustment amount, the rectified signal is again checked to see if the adjusted signal is now within the rectifier 120 power detection range. If the adjusted signal is not yet in the rectifier 120 power detection range, the process can repeat itself until the adjusted signal is in the rectifier 120 power detection range, whereupon the state of the state machine changes states again to prevent further changes to the adjustment amount. By changing states, the controller 130 can use the control signal to adjust (for example, iteratively adjust) the adjustment amount applied by the SSA 110 to the RF input signal such that the adjusted signal is within the power detection range of the rectifier 120.

In this example embodiment, the state machine is configured to change states based on the comparator signal through any method that generates state machine control signals suitable for causing the SSA 110 to adjust the attenuation or amplification of the RF input signal sufficiently to ultimately put the adjusted signal within the power detection range of the rectifier 120. For example, the state machine may have at least an ‘unsaturated’ state and a ‘saturated’ state. When the comparator signal indicates that the SSA 110 needs to make further adjustment, if the state machine is currently in the ‘saturated’ state, it can return to or maintain the saturated state wherein the state machine generates a control signal causing the SSA 110 to be adjusted. If the state machine is in the unsaturated state and the comparator signal indicates that the SSA 110 needs to make adjustment, the state machine can change states to the saturation state for providing the appropriate control signal. On the other hand, if the comparator signal indicates that no further adjustment is needed and the state machine is in the saturated state, the state machine can change from the saturated state to the unsaturated state in which the state machine generates a control signal that causes the SSA 110 to make no further adjustments, and if the state machine is already in the unsaturated state, it can merely return to or maintain that state.

In other example embodiments, the state machine may employ additional states, for example, that cause different amounts of adjustment in different states, and so forth. Moreover, the state machine may be configured to use an iterative adjustment method. In this embodiment, the state machine includes states configured to generate control signals that incrementally adjust the SSA 110 attenuation or amplification of the RF input signal.

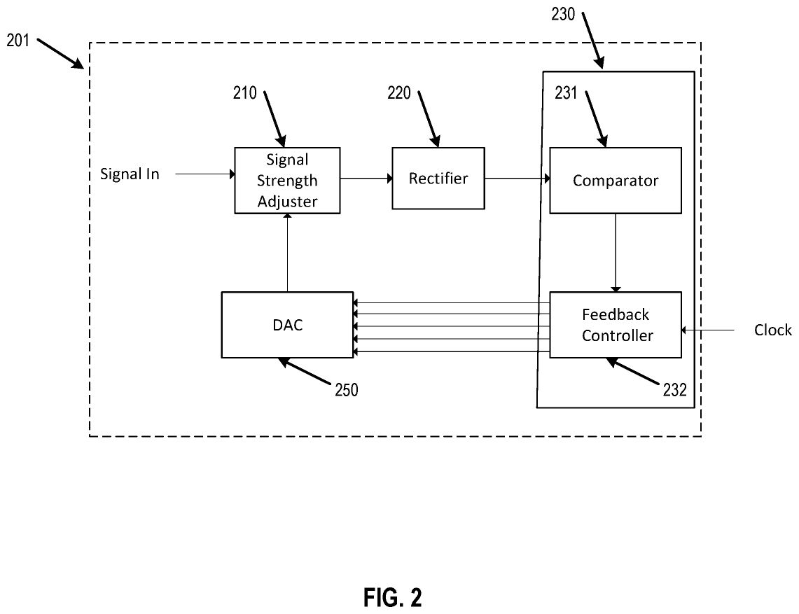

In one example embodiment, and with reference now to FIG. 2, a portion of a power meter is disclosed including an example control or feedback loop 201 of a power meter, such as the power meter 100 of FIG. 1. FIG. 2 does not show, for example, the components that output the signal power output. In an example embodiment, the feedback loop 201 of the power meter comprises an SSA 210 (similar to SSA 110), a rectifier 220 (similar to rectifier 120), and a controller 230. In this example embodiment, the controller 230 comprises or corresponds to a comparator 231 and a feedback controller 232. In this example embodiment, the comparator 231 may determine whether the rectified signal is within an expected range (e.g., the rectifier power detection range) and generate a comparator signal indicating as much to the feedback controller 232 a corresponding binary (for example, ‘1’ when within the expected range and ‘0’ when not within the expected range). For example, a power level of the rectified signal that corresponds to a maintained or repeated maximum power output of the rectifier 220 may suggest that the adjusted signal at the SSA 210 signal output exceeds the expected range for the rectifier 220. Thus, when receiving this rectified signal, the comparator 231 of the controller 230 may determine that the rectified signal is not within the expected range of the rectifier 220 and generate the comparator signal with the binary value of ‘0’. In some embodiments, the comparator 231 may generate the comparator signal with a variable or analog value that indicates, for example, a difference between the expected range and the power level of the rectified signal or the adjustment amount to be applied at the SSA 210, and so forth. The comparator 231 may provide the comparator signal to the feedback controller 232, which provides such feedback via the control signal to the SSA 210. In example embodiments, when a variable value, the feedback may indicate one or more of the adjustment amount for the SSA 210 to apply to the RF input signal, a number of times or cycles the rectified signal has exceeded the expected range, a number of adjustment steps for the SSA 210 to apply to the RF input signal, and so forth. As such, the SSA 210 may be configured to apply an appropriate power adjustment to the RF input signal based on the value of the control signal. Thus, when the comparator signal has the variable value, the SSA 210 may use the feedback control signal to adjust the RF input signal to generate the adjusted signal within the power detection range of the rectifier 220.

For example, when the SSA 210 is a variable gain amplifier and the control signal indicates the adjustment amount, the SSA 210 may apply the indicated adjustment amount to the RF input signal to generate the corresponding adjusted signal that is within the power detection range of the rectifier 220. Alternatively, when the SSA 210 is a variable attenuator and the comparator signal merely indicates that the power level of the rectified signal is not within the power detection range of the rectifier 220 (e.g., as the binary value), the SSA 210 may increase an attenuation amount applied to the RF input signal to generate the corresponding adjusted signal. Such adjustments may be repeated iteratively until the SSA 210 generates an adjusted signal that is within the power detection range of the rectifier 220.

The control loop 201 may further comprise a digital to analog converter (“DAC”) 250 for receiving digital signals from the controller 230, converting the digital signals to an analog signal, and providing an analog control signal to the SSA 210 at the control signal input, where the SSA 210 expects an analog control signal at the control signal input. The use of a DAC may facilitate variable attenuation or variable amplification in the SSA 210 where the feedback controller 232 provides one or more digital signals that the DAC 250 converts into the control signal. The one or more digital signals may indicate aspects of the feedback discussed above. In one example embodiment, the SSA 210 is a variable attenuator, and the DAC 250 is configured to provide the control signal to the variable attenuator, based on inputs received from the controller 230, for controlling the amount of attenuation of the RF input signal. In another example embodiment, the SSA 210 is a variable gain amplifier, and the DAC 250 is configured to provide the control signal to the variable gain amplifier for controlling the amount of amplification of the RF input signal.

In another example embodiment (not shown), the loop 201 comprises an analog to digital converter (ADC). In this example embodiment, the signal generated by the controller may have a bit length (e.g., a number of bits) determined by dividing a range of the RF input signal to be detected (e.g., the operational input power range of the power meter) by a detection or rectifier step size (e.g., the rectifier operational input power range) within that range. For example, a power meter having a 0-35 dB range (for example, capable of receiving the RF input signal within the 0-35 dB range) with a 5 dB rectifier step size, may employ a control signal having a bit length of 3 bits for 7 available steps. As such, the value of this control signal may indicate the amount of adjustment to the RF input signal that will result in the adjusted signal falling within the rectifier operational input power range. In some embodiments, the control signal may convey one or more of a most significant bit (MSB) or least significant bit (LSB) of the bit length to the SSA, which the SSA may use to change an adjustment applied to the RF input signal, and so forth.

With reference now to FIG. 3, in an example embodiment, a portion of a power meter is illustrated showing an example feedback loop 301 of a power meter. FIG. 3 does not show, for example, the components that output the signal power output. In an example embodiment, a control or feedback loop 301 of a power meter, such as the power meter 100, comprises a SSA 310 (similar to SSA 110) comprising any suitable number of discrete attenuators 310a-310n, a rectifier 320 (similar to rectifier 120), a comparator 340 (similar to comparator 231), and a controller 330 (similar to feedback controller 232). In this example embodiment, each of the discrete attenuators 310a-310n may be configured to provide a different discrete amount of attenuation from the other discrete attenuators. In some embodiments, the discrete attenuators are active when adding attenuation (for example, applying 16 dB attenuation when the discrete attenuator 310a is active) and inactive when not adding any attenuation (for example, applying 0 dB from discrete attenuator 310a when the discrete attenuator 310a is inactive). In an example embodiment, the controller 330 controls when each of said discrete attenuators 310a-310n will attenuate the RF input signal.

In one example embodiment not shown in FIG. 3, each discrete attenuator of the SSA 310 provides the same amount of attenuation. For example, each of the discrete attenuators 310a-310n may provide 1 dB of attenuation such that when the controller 330 indicates to apply 4 dB of attenuation, four of the discrete attenuators 310a-310n will be activated. The controller 330 is configured to generate digital signals to control the SSA 310, individually activating/deactivating the discrete attenuators 310a-310n as appropriate to obtain the desired attenuation.

In accordance with a further example embodiment, the controller 330 employs a “thermometer” or similar algorithm that selectively activates discrete attenuators 310a-310n to provide a step-wise change in attenuation via the SSA 310 and may be configured to determine which discrete attenuator(s) is/are the most appropriate to activate/deactivate. For example, via the thermometer algorithm, the controller 330 may first activate a first discrete attenuator 310a, and then activate a second discrete attenuator 310b in combination with the first discrete attenuator 310a if needed, before activating a third discrete attenuator 310c in combination with the first and second discrete attenuators 310a and 310b. Where each of the discrete attenuators 310a-310n introduces the same amount of attenuation (e.g., each provides 1 dB of attenuation), this thermometer algorithm enables the SSA 310 to incrementally increase attenuation 1 dB at a time. In some embodiments, the controller 330 may employ the thermometer algorithm when the discrete attenuators provide different amounts of attenuation, as shown in FIG. 3, but to provide similar features of incremental attenuation increase with different increments. For example, the controller 330 may incrementally increase the attenuation applied by the SSA 310 starting with the smallest discrete attenuator (e.g., the ⅛ dB attenuator), then switch to the ¼ dB attenuator, then turn on both the ⅛ and ¼ dB attenuators to provide ⅜ dB attenuation, etc.

Alternatively, the controller 330 may employ a successive approximation algorithm, with which the controller 330 uses successive or iterative steps to perform a best approximation of a change. More specifically, the controller 330 employing the successive approximation algorithm involves determining at each step whether the power level of the rectified signal is above or below the predetermined threshold using the comparator 340 and the controller 330, and the controller 330 iterating the attenuation applied by the SSA 310 to bring the rectified signal power level closer to that predetermined threshold. For example, with the discrete attenuators as shown in FIG. 3, the controller 330 employing the successive approximation algorithm may first activate the discrete attenuator 310a with the 16 dB of attenuation. The controller 330 may then determine, based on the comparison of the resulting rectified signal with the predetermined threshold by the comparator 340, whether to increase attenuation via activating the 8 dB discrete attenuator 310b in combination with the 16 dB discrete attenuator 310a where additional attenuation is needed or to decrease attenuation via activating the 8 dB discrete attenuator 310b without the 16 dB discrete attenuator 310a. Where the controller activates the 8 dB discrete attenuator 310b without the 16 dB discrete attenuator 310a, the controller 330 may then determine, based on the comparison of the resulting rectified signal with the predetermined threshold by the comparator 340, whether to increase attenuation via activating the 4 dB discrete attenuator 310c in combination with the 8 dB discrete attenuator 310b where additional attenuation is needed or to decrease attenuation via activating the 4 dB discrete attenuator 310c without the 8 dB discrete attenuator 310b. In some embodiments, the successive approximation algorithm may result in the attenuation that places the RF input signal power level in the power detection range of the rectifier 320 more quickly than the thermometer algorithm. In some embodiments, the controller 330 may be configured to control the attenuation based on a binary search through successive approximation. In this example embodiment, the system 300 may, for example, set the SSA 310 at the mid-point, and use the controller 330 to determine whether to adjust the signal strength up or down. In that example, it may start at 50%, determine that it is low, step up to 75%, determine that this is too high, and set to 62.5%, and continue iterating in this manner to arrive at a suitable amount of adjustment. Other approaches may be used, such as, a sweep method where the adjustment starts at a value (such as zero) and increases or decreases, linearly, exponentially, or otherwise, until the adjusted signal is within the power detection range of the rectifier 320. Any suitable control approach may be implemented that results in adjusting the power level of the RF input to be suitable for the rectifier 320. In another example embodiment, the comparator 340 may be a multilevel comparator (e.g., flash ADC) and the controller 330 may receive the output from the multilevel comparator 340 and control the SSA 310 as described above. In this example embodiment, the power meter output signal may be based on the rectifier output and a combination of the attenuation applied by the respective ADC outputs.

In one example embodiment, the controller is configured to generate a plurality of digital signals for control of the SSA, such as the feedback controller 232 of FIG. 2. In such an example embodiment, the plurality of digital signals can be provided directly to the SSA, more specifically to respective ones of a plurality of discrete attenuators for switching the respective ones of the plurality of discrete attenuators between an on state and an off state.

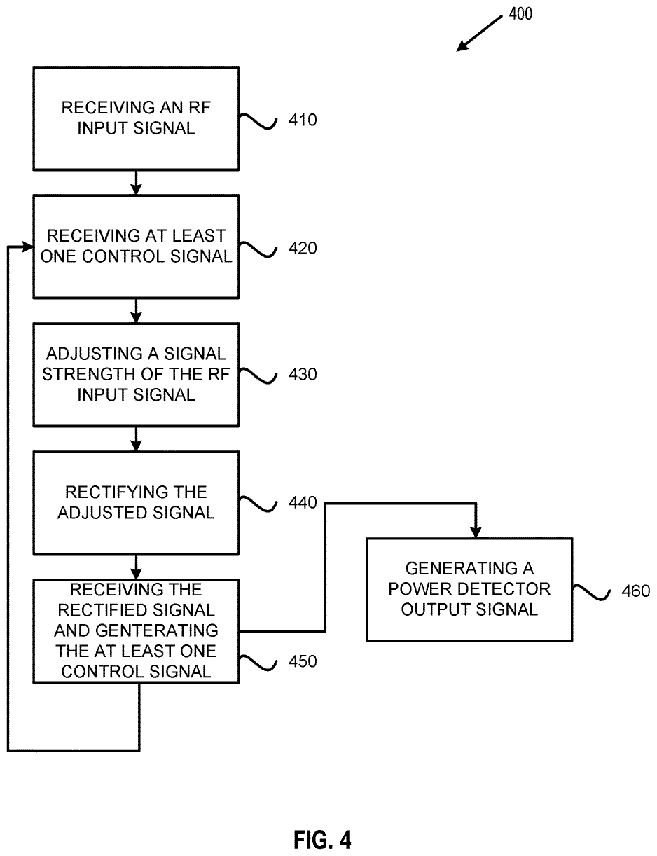

In accordance with an example embodiment, and with reference now to FIG. 4, a method 400 of detecting the power in a radio frequency (“RF”) input signal is disclosed. The method 400 may include additional and/or a subset of the aspects depicted and described. The method 400 may be suited to detecting power in the RF input signal over a power detector operational input power range that is greater than a rectifier operational input power range of a single rectifier used in the power detector. In one example embodiment, the method comprises: (410) receiving, at an SSA (such as one of the SSA 110 or the SSA 310), an RF input signal. The method 400 may further include: (420) receiving, at the SSA, at least one control signal (from, for example, the controller 130). The at least one control signal may indicate to the SSA an adjustment amount to apply to the RF input signal. In some embodiments, the at least one control signal may comprise a default that indicates to the SSA that no adjustment is made to the RF input signal on a first iteration through the power meter and/or when the RF input signal is initially received at SSA. In some embodiments, the default value may comprise any value indicating an initial adjustment amount to apply to the RF input signal on an initial iteration through the power meter.

The method 400 may also include: (430) adjusting a signal strength of the RF input signal by the adjustment amount to generate an adjusted signal. As introduced above, the adjustment amount may be based on the at least one control signal. In a further example embodiment, the at least one control signal may be based on a comparator signal from a comparator receiving the adjusted signal.

In the example embodiment, the method 400 further comprises: (440) rectifying, with a single rectifier (such as the rectifier 120 or the rectifier 320), the adjusted signal to generate a rectified signal.

The method 400 further comprises: (450) receiving the rectified signal at a controller (such as one of the controller 130 or 330) and generating, at a controller, at least one control signal based on the rectified signal. In an example embodiment, the at least one control signal may be a feedback signal configured to cause the SSA to adjust the RF input signal by an adjustment amount for the purpose of bringing the rectified signal within a power detection range of the rectifier.

In one example embodiment, the controller optionally comprises a comparator for comparing the rectified signal to a predetermined threshold. In some embodiments, as discussed above, the predetermined threshold may comprise one or more values stored and/or obtained from a memory, from the rectifier, from a user interface, and so forth. In various example embodiments, the predetermined threshold is stored as part of the power meter, in a local memory, on a remote server, and/or the like. In various embodiments, the predetermined threshold could be a set reference voltage level, adjustable or permanently set, hardwired in the controller, or stored in memory. In an example embodiment, the comparator generates the control signal. In another example embodiment, the comparator generates a comparator output signal that is provided to a feedback controller that generates the control signal. The control signal may be configured to cause the SSA to adjust the power level in the RF input signal. In an example embodiment, the method loops back to (420) to adjust the signal strength of the RF input signal with an adjustment amount controlled by the control signal in an iterative process. This loop can repeat until the SSA has adjusted the RF input signal power (attenuation or amplification) sufficient to satisfy the predetermined threshold (i.e., sufficient to be within a power detection range of the rectifier). In another example embodiment, the comparator provides a controller an input (e.g., a comparator output) indicating whether the attenuated signal is within a detection range of the single rectifier, and the controller is configured to change the state of a digital-to-analog converter (“DAC”) such that the SSA continues to iteratively adjust the adjustment amount until the adjusted signal is within the detection range of the single rectifier.

Once the controller has commanded the SSA to sufficiently adjust the power in the RF input signal, the method 400 may comprise: (460) generating, at a processor (such as the processor 180), a power detector output signal representing the power in the RF input signal, based on the rectified signal. The power detector output signal may be generated based on one or more of a combination of the rectified signal and an amount that the RF input signal was adjusted by the controller (e.g., the at least one control signal), the rectified signal, the amount of adjustment, and so forth.

In one example embodiment, as discussed above, the SSA is a variable attenuator, and adjusting the strength of the RF input signal by the adjustment amount comprises adjusting the attenuation of the RF input signal, through successive approximation (binary search) until the power at the output of the variable attenuator reaches a threshold of the rectifier.

In another example embodiment, the attenuation is performed using successive approximation attenuation. In another example embodiment, the SSA is a variable gain amplifier, and adjusting the strength of the RF input signal by the adjustment amount comprises adjusting the gain of the RF input signal.

In accordance with various example embodiments, the power meter may be configured to report the amount of attenuation or amplification (and/or the input power detected) to a remote system, store this information in a database, or put the information to other use.

In accordance with various example embodiments, the ability for one power meter to work for detecting various ranges of power levels, makes it possible to use the same power meter in many different applications. Moreover, the power meter may be useful in applications where the RF input signals to be detected may change the power levels from time to time.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “includes,” “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. A power meter for measuring the power level of a radio frequency (“RF”) input signal over a first input power detection range, comprising:
a signal strength adjuster (SSA) to receive a radio frequency (“RF”) input signal, adjust the strength of the RF input signal by an adjustment amount in response to a control signal, and generate an adjusted signal;
a rectifier to rectify the adjusted signal and generate a rectified signal, wherein the rectifier is limited to rectifying over a rectifier input power detection range that is narrower than the first input power detection range, wherein the rectified signal in combination with the adjustment amount represents a detected power in the RF input signal; and
a controller to control the SSA using the control signal that is based on the rectified signal to cause the adjusted signal to be within a detection range of the rectifier.

2. The power meter of claim 1, wherein the first input power detection range is a range of power over which the power meter can detect the power in the RF input signal, and wherein the rectifier input power detection range is an operational input power range over which the rectifier can reliably detect the power in a signal input to the rectifier, and wherein the first input power detection range is at least double the rectifier input power range.

3. The power meter of claim 1, wherein the SSA is one of an attenuator or an amplifier.

4. The power meter of claim 1, wherein the SSA is a variable attenuator, the power meter further comprising: a digital to analog converter (“DAC”) for receiving the control signal from the controller and for providing an analog control signal to the variable attenuator controlling the amount of attenuation of the RF input signal.

5. The power meter of claim 1, wherein the SSA comprises a series of discrete attenuators each configured to provide a discrete amount of attenuation, and wherein the controller controls when each of said discrete attenuators will attenuate the RF input signal.

6. The power meter of claim 1, wherein the SSA is a variable gain amplifier that adjusts the RF input signal based on the control signal from a digital-to-analog converter, and wherein the control signal is based on at least one signal from the controller.

7. The power meter of claim 1, wherein the controller controls attenuation based on a binary search through successive approximation.

8. The power meter of claim 1, wherein the controller is configured to generate a plurality of digital signals for control of the SSA, wherein the plurality of digital signals are provided to respective ones of a plurality of discrete attenuators for switching the respective ones of the plurality of discrete attenuators between an on state and an off state.

9. The power meter of claim 1, wherein the controller further comprises a comparator to compare the rectified signal to a predetermined threshold and to generate a comparator signal indicating whether the rectified signal is within the detection range of the rectifier, and wherein the control signal is based on the comparator signal.

10. A wireless communication system comprising:
a power meter for measuring a power level of a radio frequency (“RF”) input signal, comprising:
a signal strength adjuster (SSA) to receive a radio frequency (“RF”) input signal, to adjust a strength of the RF input signal by an adjustment amount in response to a control signal, and to generate an adjusted signal;
a rectifier for rectifying the adjusted signal and generating a rectified signal representing a detected power in the RF input signal; and
a controller to provide the control signal to the SSA based on the rectified signal to cause the adjusted signal to be within a detection range of the rectifier.

11. The system of claim 10, wherein the power meter does not comprise rectifiers in parallel or cascaded rectifiers.

12. The system of claim 10, wherein the power meter comprises a single rectifier.

13. The system of claim 10, wherein the system is configured to generate a power meter output signal representing the detected power in the RF input signal, without rectifier alignment or calibration for alignment of multiple rectifiers.

14. The system of claim 12, wherein an operational input power range of the power meter is greater than an operational input power range of the single rectifier of the power meter.

15. The system of claim 10, wherein the controller further comprises a comparator to compare the rectified signal to a predetermined threshold and to generate a comparator signal indicating whether the rectified signal is within the detection range of the rectifier, and wherein the control signal is based on the comparator signal.

16. A method of detecting the power in a radio frequency (“RF”) input signal over a detector operational input power range that is greater than a rectifier operational input power range of a single rectifier used in the detector, the method comprising:
receiving at a signal strength adjuster (SSA) an RF input signal;
receiving, at the SSA, at least one control signal;
adjusting a strength of the RF input signal by an adjustment amount to generate an adjusted signal, wherein the adjustment amount is based on the at least one control signal;
rectifying, with a single rectifier, the adjusted signal to generate a rectified signal;
generating, at a controller, the at least one control signal based on the rectified signal to cause the adjusted signal to be within a detection range of the single rectifier; and
generating a power detector output signal representing the power in the RF input signal, based on the rectified signal and an amount of adjustment made by the SSA.

17. The method of claim 16, further comprising comparing, with a comparator, the rectified signal to a predetermined threshold to generate a comparator signal, wherein the at least one control signal is based on the comparator signal.

18. The method of claim 16, wherein the SSA is a variable attenuator, and wherein adjusting the strength of the RF input signal by the adjustment amount comprises adjusting the attenuation of the RF input signal, through successive approximation (binary search) until the power at an output of the variable attenuator reaches a threshold of the single rectifier.

19. The method of claim 17, wherein the power detector output signal is based on the summation of the rectified signal and the adjustment amount; and wherein the comparator provides the comparator signal indicating whether the attenuated signal is within the detection range of the single rectifier, and wherein the controller is configured to change the state of a digital-to-analog converter (“DAC”) such that the SSA continues to iteratively adjust the adjustment amount until the adjusted signal is within the detection range of the single rectifier.

20. The method of claim 16, wherein the attenuation is performed using successive approximation attenuation.

21. The method of claim 16, wherein the SSA is a variable gain amplifier, and wherein adjusting the strength of the RF input signal by the adjustment amount comprises adjusting the gain of the RF input signal.
